(19) United States
(12) Patent Application Publication
(10) Pub. No.: US 2025/0169550 A1
(43) Pub. Date: May 29, 2025

(54) AEROSOL PROVISION DEVICE

(71) Applicant: NICOVENTURES TRADING LIMITED, London (GB)

(72) Inventors: Jai TAANK, London (GB); Mark LEGG, London (GB); Jonathan Neil BURGESS, London (GB); Eoin GEARY, London (GB)

(21) Appl. No.: 18/842,453

(22) PCT Filed: Mar. 1, 2023
(86) PCT No.: PCT/EP2023/055235

§ 371 Date: Aug. 29, 2024

(30) Foreign Application Priority Data
Mar. 2, 2022 (GB) 2202913.6

(51) Int. Cl. A24F 40/85; A46B 3/18; A46B 9/02; A46B 15/00; B08B 1/16

(52) U.S. Cl. CPC A24F 40/85; A46B 3/18; A46B 9/026; A46B 15/0081; B08B 1/165; A46B 2200/3073

(57) ABSTRACT

A cleaning tool for an aerosol provision device, the cleaning tool including a cleaning head having a loop support and a plurality of bristles extending from the loop support.

### RELATED APPLICATIONS

The present application is a National Phase entry of PCT Application No. PCT/EP2023/055235 filed Mar. 1, 2023, which claims priority to GB Application No. 2202913.6 filed Mar. 2, 2022, each of which is hereby incorporated by reference in their entirety.

### TECHNICAL FIELD

The present invention relates to a cleaning tool for an aerosol provision device, a method of cleaning an aerosol provision device, a method of manufacturing a cleaning tool and an aerosol provision system.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use induction heating systems as heaters to create an aerosol from a suitable medium. An induction heating system generally consists of a magnetic field generating device for generating a varying magnetic field, and a susceptor or heating material which is heatable by penetration with the varying magnetic field to heat the suitable medium. It is also known to use a resistive heater to create aerosol from a suitable medium. A heating element may refer to an element configured to heat the suitable medium, and can be either a resistive heating element or a susceptor or heating material which is heatable by penetration with the varying magnetic field.

Conventional aerosol provision devices comprise a cylindrical heating chamber into which a rod shaped consumable is inserted.

During use, dirt can accumulate on the heating element and/or in the heating chamber of an aerosol provision device.

### SUMMARY

According to an aspect there is provided a cleaning tool for an aerosol provision device, the cleaning tool comprising:
a cleaning head comprising a loop support and a plurality of bristles extending from the loop support.

The cleaning tool according to various embodiments has been found to be particularly effective in removing dirt or contaminants which has accumulated upon a heating element or a surface of a heating chamber of an aerosol provision device.

Optionally, the heating element may be a blade, or a pin.

Optionally, the loop support is formed from at least two strands of wire which are twisted together to secure the bristles in position.

Optionally, the bristles extend radially from the loop support.

Optionally, the cleaning tool further comprises a loop housing, wherein the loop support extends from the loop housing.

Optionally, the loop housing is arranged and adapted to engage with or contact a proximal surface of an aerosol provision device.

Optionally, the loop support comprises a first section proximal to the loop housing and a second section distal from the loop housing, wherein the bristles extending from the first section of the plurality of bristles extend from the loop support by a first distance and the bristles extending from the second section of the plurality of bristles extend from the loop support by a second distance, wherein the second distance is greater than the first distance.

Optionally, the loop support comprises a first section proximal to the loop housing and a second section distal from the loop housing, wherein the plurality of bristles extend from the first section of the loop support and the second section of the loop support does not have any bristles.

Optionally, the loop support comprises a first portion provided in a first plane.

Optionally, the loop support comprises a second portion which is angled away from the first plane.

Optionally, the angle of the second portion with respect to the first portion is selected from the ranges: 0-30 degrees; 30-60 degrees; or 60-90.

Optionally, the first portion comprises two portions which are spaced apart from each other, and the second portion connects the two portions of the first portion.

Optionally, the two portions of the first portion are parallel and are spaced apart from each other in a direction perpendicular to a longitudinal axis of a heating element of an aerosol provision device by a distance greater than a maximum width of the heating element in the direction perpendicular to the longitudinal axis, and wherein the second portion connecting the two parallel portions is angled or otherwise bent such that the second portion does not contact the heating element in use or engagement of the cleaning tool with an aerosol provision device.

Optionally, in use or engagement of the cleaning tool with an aerosol provision device, the loop support is arranged to surround but not contact a heating element of the aerosol provision device.

Optionally, the cleaning tool comprises an outer housing defining a cavity which houses the loop support and which is dimensioned to receive, in use, an outer wall of a heating chamber or housing of an aerosol provision device.

Optionally, the outer housing is substantially cylindrical and wherein the outer housing defines a substantially cylindrical cavity which houses the cleaning head.

Optionally, the outer housing comprises a cleaning mode engagement mechanism for engaging with an aerosol provision device, the cleaning mode engagement mechanism enabling the cleaning tool to be rotated relative to the aerosol provision device.

Optionally, the outer housing comprises an attachment mechanism for securing the cleaning tool to one or more slots or cut-outs provided in an aerosol provision device.

Optionally, the cleaning tool comprises a handle portion and wherein the cleaning head is provided at one end of the handle portion and a scraper tool comprising a scraper is provided at another end of the handle portion.

Optionally, the cleaning tool comprises a scraper tool which is detachable from the cleaning head, wherein the scraper tool comprises a scraper, and wherein, when not in use or engagement with an aerosol provision device, the scraper tool is arranged and adapted to engage with the cleaning head so as to secure the scraper tool to the cleaning head.

Optionally, the scraper tool comprises a scraper housing from which the scraper extends, and wherein the scraper comprises:
a straight shaft having an end distal from the scraper housing;
a flexible layer surrounding a portion of the straight shaft; and
a scraper tip portion positioned at the distal end of the straight shaft.

Optionally, the flexible layer comprises silicone.

Optionally, the flexible layer comprises bump features.

Optionally, the flexible layer comprises a spiral channel.

Optionally, the cleaning tool further comprises a silicone support plug, wherein, in use or engagement with an aerosol provision device, the silicone support plug is configured so as to support a heating element of the aerosol provision device, such that the heating element is protected from snapping or otherwise breaking under the action of a contact force exerted by a user through the loop structure of the cleaning tool onto the heating element whilst engaging the cleaning tool with the aerosol provision device and/or when using the cleaning tool on the aerosol provision device.

Optionally, the cleaning head comprises the silicone plug, the silicone plug being positioned adjacent to the loop support.

Optionally, the cleaning tool comprises two or more loop supports.

Optionally, the bristles are formed from PEEK.

According to another aspect there is provided a method of cleaning an aerosol provision device comprising:
attaching a cleaning tool as described above to an aerosol provision device such that the cleaning tool and the aerosol provision device share a longitudinal axis; and:
(i) rotating the cleaning tool relative to the aerosol provision device about the longitudinal axis by at least a partial rotation; and/or
(ii) translating the cleaning tool relative to the aerosol provision device axially along the longitudinal axis in at least one direction.

According to another aspect there is provided a method of manufacturing a cleaning tool comprising:
providing a support having a plurality of bristles extending therefrom;
trimming the bristles either side of a central section of the support so that after trimming the bristles extend a maximum extent in the central section; and
bending the support to form a loop.

According to another aspect there is provided an aerosol provision system comprising:
an aerosol provision device configured to produce aerosol from an aerosol generating article; and
a cleaning tool as described above.

Optionally, the aerosol provision system further comprises an aerosol generating article for insertion into the aerosol provision device.

### BRIEF DESCRIPTION OF THE DRAWINGS

Various embodiments will now be described by way of example only and with reference to the accompanying drawings in which:

FIG. 1A shows an aerosol provision device located within a charging unit according to an embodiment, FIG. 1B shows an aerosol provision device in isolation from the charging unit and FIG. 1C shows a cross-sectional view of an aerosol provision device located within a charging unit;

FIG. 2A shows a perspective view of an upper part of an aerosol provision device, FIG. 2B shows a perspective view of the upper part of the aerosol provision device with an aerosol generating article inserted therein, FIG. 2C shows a perspective view of internal components of the upper part of the aerosol provision device and FIG. 2D shows a perspective view of the upper part of the aerosol provision device with a removable cap removed to show the heating element;

FIG. 3A shows a perspective view of a cleaning tool for an aerosol provision device according to an embodiment, FIG. 3B shows a perspective view of the cleaning tool without bristles for illustrative purposes, FIG. 3C shows a face-on view of the components shown in FIG. 3B, FIG. 3D shows a side-on view of the components shown in FIG. 3B, FIG. 3E shows a perspective view of a cleaning tool for an aerosol provision device according to an embodiment with an outer housing shown as being transparent for illustrative purposes and FIG. 3F shows the outer housing shown opaque;

FIG. 4A shows an aerosol provision device with a removable cap according to an embodiment, FIG. 4B shows the aerosol provision device with the removable cap removed, FIG. 4C shows an aerosol provision device with a cleaning tool mounted to the aerosol provision device in order to clean a heating element, main housing or heating chamber of the aerosol provision device and FIG. 4D shows an aerosol provision device with a cleaning tool mounted to the aerosol provision device with the cleaning tool in a twisted position such that the bristles of the cleaning tool are arranged to clean the heating element, main housing or heating chamber of the aerosol provision device whilst not contacting the heating element of the aerosol provision device;

FIG. 5A shows a perspective view of a cleaning tool for an aerosol provision device according to an embodiment, FIG. 5B shows a perspective view of a cleaning tool for an aerosol provision device according to an embodiment, FIG. 5C shows a part of a scraper of a cleaning tool according to an embodiment, FIG. 5D shows a part of a scraper of a cleaning tool according to an embodiment, FIG. 5E shows a perspective view of a cleaning tool for an aerosol provision device according to an embodiment with the cleaner head shown separate from the scraper tool, FIG. 5F shows the cleaning tool according to an embodiment with the cleaner head and scraper tool secured to each other and FIG. 5G shows the cleaning tool with the outer housings thereof shown transparent for illustrative purposes; and

FIG. 6A shows a perspective view of a cleaning tool for an aerosol provision device according to an embodiment, FIG. 6B shows a perspective view of a cleaning tool for an aerosol provision device according to an embodiment and FIG. 6C illustrates the process of fabricating a cleaning tool according to an embodiment.

### DETAILED DESCRIPTION

Aspects and features of certain examples and embodiments are discussed or described herein. Some aspects and features of certain examples and embodiments may be implemented conventionally and these are not discussed or described in detail in the interests of brevity. It will thus be appreciated that aspects and features of apparatus and methods discussed herein which are not described in detail may be implemented in accordance with conventional techniques for implementing such aspects and features.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

Aerosol-generating material is a material that is capable of generating aerosol, for example when heated, irradiated or energized in any other way. Aerosol-generating material may, for example, be in the form of a solid, liquid or semi-solid (such as a gel) which may or may not contain an active substance and/or flavorants.

The aerosol-generating material may comprise a binder and an aerosol former.

Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise one or more active substances and/or flavors, one or more aerosol-former materials, and optionally one or more other functional material.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

A consumable is an article comprising or consisting of aerosol-generating material, part or all of which is intended to be consumed during use by a user. A consumable may comprise one or more other components, such as an aerosol generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component. However, in other implementations the aerosol generating article may comprise partially, or entirely, the aerosol generating component.

For completeness, aerosol provision devices comprising an inductive element are known. The aerosol provision device may comprise one or more inductors and a susceptor which is arranged to be heated by the one or more inductors.

A susceptor is a heating material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The aerosol provision device that is configured to generate the varying magnetic field is referred to as a magnetic field generator, herein.

Various embodiments will now be described in more detail.

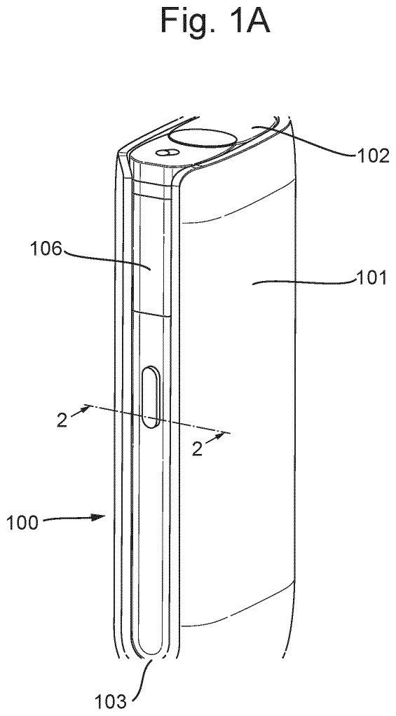

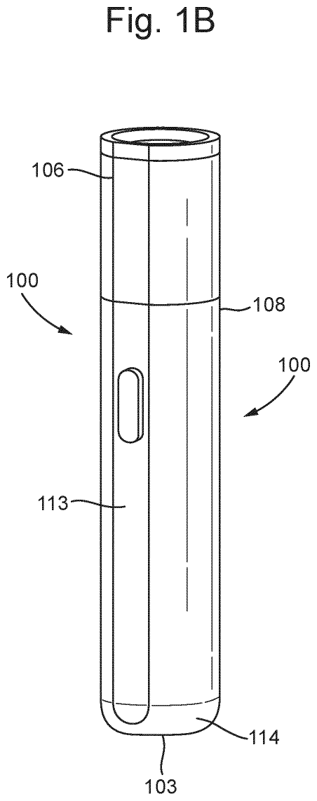

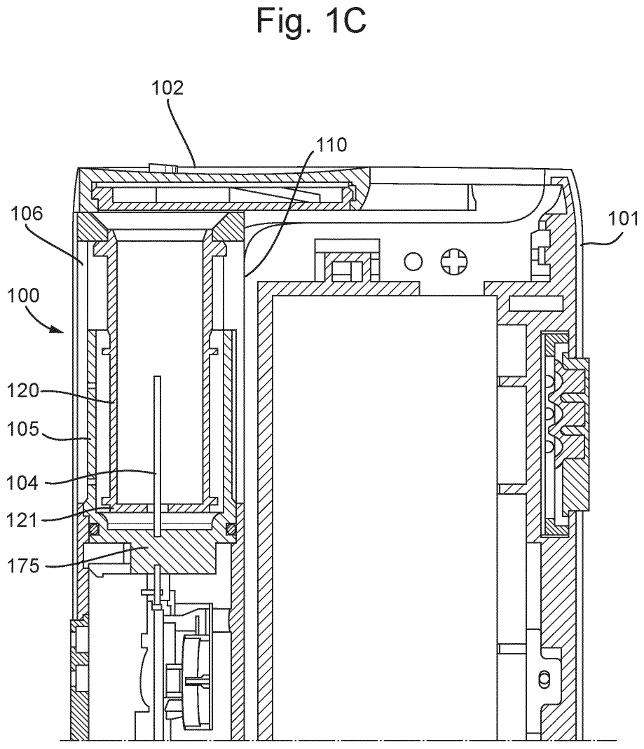

FIG. 1A shows an aerosol provision device 100 according to an embodiment shown located within a charging unit 101. The aerosol provision device 100 is shown located within an elongate cavity 110 of the charging unit 101. FIG. 1B shows the aerosol provision device 100 of FIG. 1A in isolation. FIG. 1C shows a cross-sectional view of the aerosol provision device 100 and charging unit 101 above line 2-2 in FIG. 1A showing the aerosol provision device 100 located or docked within the charging unit 101.

The charging unit 101 may comprise a power source (not shown). The power source may include, for example, a battery (single-use or rechargeable), a rechargeable super capacitor, a rechargeable solid-state battery (SSB), a rechargeable lithium-ion battery (LiB) or the like, a hermetically sealed battery, a pouch cell battery or some combination thereof.

The aerosol provision device 100 may be left in the charging unit 101 for a predetermined time in order to allow sufficient charging of the aerosol provision device 100. For example, the charging unit 101 may be arranged to charge the aerosol provision device 100 to full charge in a time of <10 mins, 10-20 mins, 20-30 mins, 30-40 mins, 40-50 mins, 50-60 mins or >60 mins.

The charging unit 101 and/or the aerosol provision device 100 may optionally have an indicator to give a visual or other representation to the user of the charging level of the aerosol provision device 100. Additionally, there may be a separate indicator to give a visual representation of the charge level of the charging unit 101. The current charge level of the aerosol provision device 100 and/or the charging unit 101 may be determined by control means disposed in the aerosol provision device 100 and/or the charging unit 101.

The visual indicator may comprise one or more light-emitting diodes (LEDs). However, other embodiments are contemplated where the visual indicator may be replaced by an audio indicator (e.g. a speaker) or a haptic indicator.

The aerosol provision device 100 may comprise an outer housing 108 which may have a tubular and/or cylindrical shape, or a substantially tubular and/or cylindrical shape.

For instance, as shown in FIG. 1B, the outer housing 108 of aerosol provision device 100 may be cylindrical bar from: (i) a planar region 113 truncating the cylindrical shape and running longitudinally along the length of the outer housing; and (ii) a bevelled region 114 located at the distal end 103 of the aerosol provision device 100. However, other embodiments are envisaged wherein the aerosol provision device 100 may take other desired forms e.g. the aerosol provision device 100 may be box shaped. According to an embodiment the outer housing 108 of the aerosol provision device 100 may comprise an electrical insulator and may, for example, be formed of polyetheretherketone (“PEEK”).

As discussed, the aerosol provision device 100 may be substantially rod-like, substantially tubular shaped, or substantially cylindrically shaped. In other examples, the aerosol provision device 100 may also be substantially rectangular, rhomboidal or triangular in cross-section, multifaceted shapes, or the like. It will be appreciated that the cavity 110 of the charging unit 101 can be manufactured according to the shape of the aerosol provision device 100 e.g. the cavity 110 of the charging unit 101 may be correspondingly substantially rod-like, substantially tubular shaped, or substantially cylindrically shaped, substantially rectangular, rhomboidal or triangular in cross-section, multifaceted shapes, or the like.

Still referring to FIGS. 1A-1C, the aerosol provision device 100 may be inserted into the cavity 110 of the charging unit 101 in order to recharge the aerosol provision device 100 by receiving electrical power from the charging unit 101. The charging unit 101 may comprise an internal battery to provide electrical power to the aerosol provision device 100. The charging unit 101 may also be connected to an external source of electrical power.

The charging unit 101 may comprise a lid or cover 102 which may be actuated by a user between an open and closed position e.g. the lid or cover 102 may be slid in a direction as indicated by the dashed arrow shown in FIG. 1C from a closed position to an open position. The lid or cover 102 is provided at the entrance to the cavity 110 which is provided within the charging unit 101 and which is configured to receive the aerosol provision device 100.

The aerosol provision device 100 includes an aerosol generator for generating aerosol from aerosol generating material. According to an embodiment the aerosol provision device 100 comprises a resistive heater for heating an aerosol generating article.

When the lid or cover 102 is in the open position an opening to the cavity 110 is exposed thereby enabling a user to either remove the aerosol provision device 100 from the charging unit 101 (in order to use the aerosol provision device 100) or alternatively to insert the aerosol provision device 100 into the charging unit 101 (in order to charge the aerosol provision device 100).

Referring to FIG. 1C, the aerosol provision device 100 comprises a main housing 105 wherein a heating element 104 projects within the main housing 105. The aerosol provision device 100 further comprises a removable cap 106 which may be magnetically retained to the main housing 105.

A consumable cartridge 120 may be attached to the removable cap 106 and comprises a tubular housing having a base portion 121. The base portion 121 of the consumable cartridge 120 has an aperture and the heating element 104 is arranged to project through the aperture.

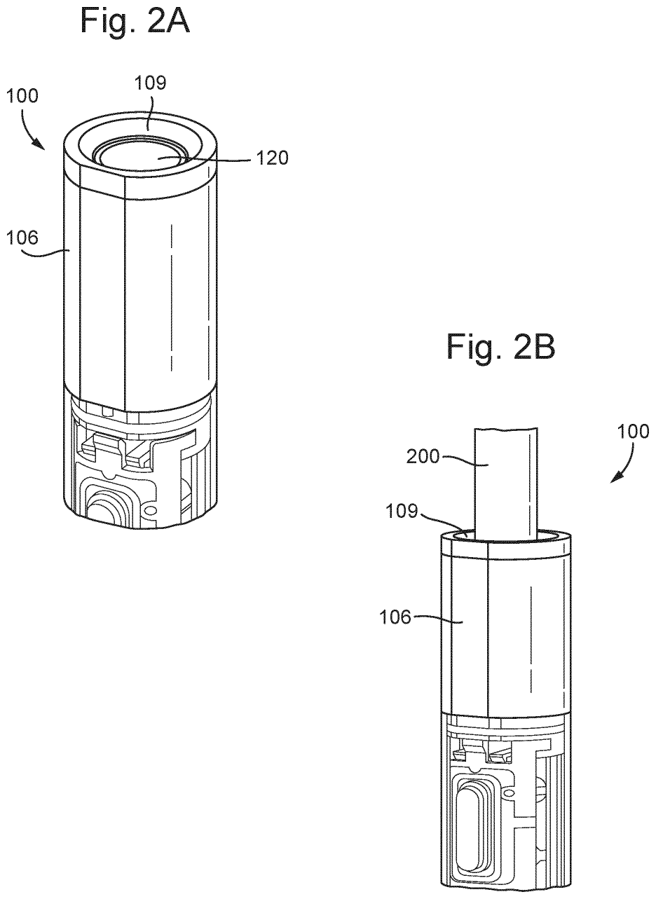

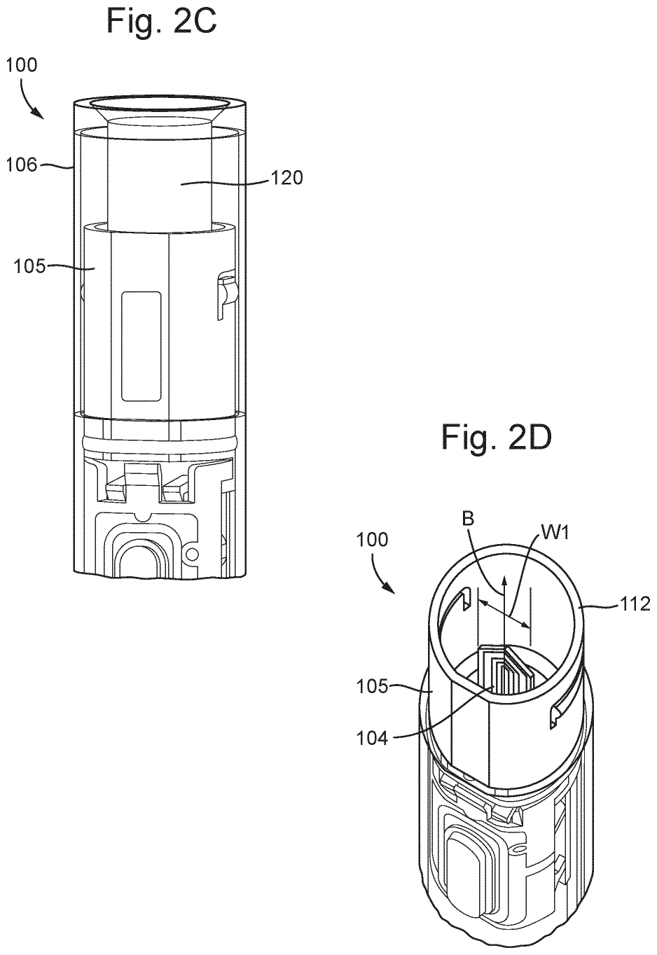

FIGS. 2A-2D show various perspective views of the upper part of the aerosol provision device 100 when separate from the charging unit 101, wherein the outer housing 108 is shown as see-through for illustrative purposes.

FIG. 2A shows the removable cap 106 attached to the main housing 105 of the aerosol provision device 100 without an aerosol generating article inserted therein, whereas FIG. 2B shows an aerosol generating article 200 inserted into the removable cap 106 when attached.

FIG. 2C shows the removable cap 106 with an outer housing of the removable cap 106 being translucent so as to show the main housing 105 of the aerosol provision device 100 relative to the consumable cartridge 120 of the removable cap 106.

FIG. 2D shows the aerosol provision device 100 with the removable cap 106 removed, revealing the heating element 104 projecting within the main housing 105. In FIG. 2D, a proximal surface 112 of the aerosol provision device 100 is shown as the end surface of main housing 105.

As shown in FIG. 2B, an aerosol generating article 200 may be inserted into the aerosol provision device 100 by inserting the aerosol generating article 200 through an opening 109 in the removable cap 106 and then inserting the aerosol generating article 200 into the consumable cartridge 120 and onto the heating element 104. The heating element 104 may have a blade like profile as shown in FIG. 2D, and in use an aerosol generating article 200 may be forced onto the heating element 104 so that the blade like profile of the heating element 104 inserts into a distal end of the aerosol generating article 200 along a blade direction B. The heating element 104 is arranged to internally heat the aerosol generating article 200. It will be understood that the heating element 104 may have a different blade like profile than that shown in FIG. 2D, or may alternatively comprise a pin.

Accordingly, aerosol may be generated from aerosol generating material which comprises the aerosol generating article 200 when the aerosol generating article 200 is heated by the heating element 104.

In some embodiments, the heating element 104 may comprise a resistive heating element, wherein the aerosol provision device is configured so as to pass an electrical current through the resistive heating element 104 in order to resistively heat the heating element 104.

Alternatively, the heating element may comprise a susceptor or other heating material which is heatable by penetration therethrough by a varying magnetic field. In such embodiments, the aerosol provision device 100 may comprise one or more magnetic field generators (such as one or more induction coils) which are arranged to generate a varying magnetic field which penetrates the susceptor or other heating material, thereby heating the heating element.

At the end of a session of use, when an aerosol generating article 200 has been consumed, the removable cap 106 and attached consumable cartridge 120 may then be detached from the main housing 105. It will be understood that the process of detaching the removable cap 106 and attached consumable cartridge 120 will have the effect that the base portion 121 of the consumable cartridge 120 will contact a bottom face of the aerosol generating article 200. As the removable cap 106 and attached consumable cartridge 120 are withdrawn, then the base portion 121 of the consumable cartridge 120 will contact the distal end of the aerosol generating article 200 and will result in the aerosol generating article 200 being pulled off or otherwise removed from the heating element 104.

In other embodiments, aerosol may be generated within a heating chamber of the aerosol provision device 100. For instance, the consumable cartridge 120 may be attached to the aerosol provision device 100 so as to form a heating chamber.

Over a period of time the heating element 104 and/or a surface of the main housing 105 and/or a surface of a heating chamber of the aerosol provision device 100 may become dirty or otherwise covered with a contaminant. In particular the heating element 104 and/or a surface of the main housing 105 and/or a surface of a heating chamber of the aerosol provision device 100 may become covered with a deposit of spent aerosol generating material from the aerosol generating article 200.

Furthermore, aerosol generating material which has not been fully consumed may be left on the heating element 104 or may be deposited upon an inner surface of the main housing 105.

Accordingly, it is desirable to periodically clean the heating element 104 and/or a surface of the main housing 105. As will be understood, deposits of spent aerosol generating material and/or aerosol generating material which has not been completely consumed may reach the main housing 105 e.g. through an aperture provided in the base portion 121 of the consumable cartridge 120 through which the heating element 104 of the aerosol provision device 100 projects.

It is therefore desirable to clean the heating element 104 and/or a surface of the main housing 105 of aerosol provision device 100. Cleaning the heating element 104 and the main housing 105 and/or a heating chamber of an aerosol provision device may be problematic.

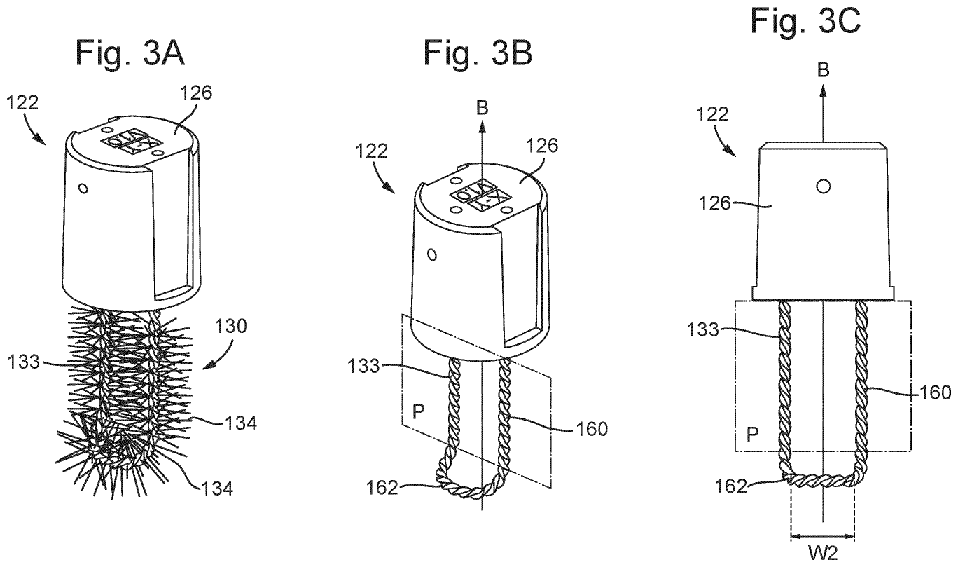

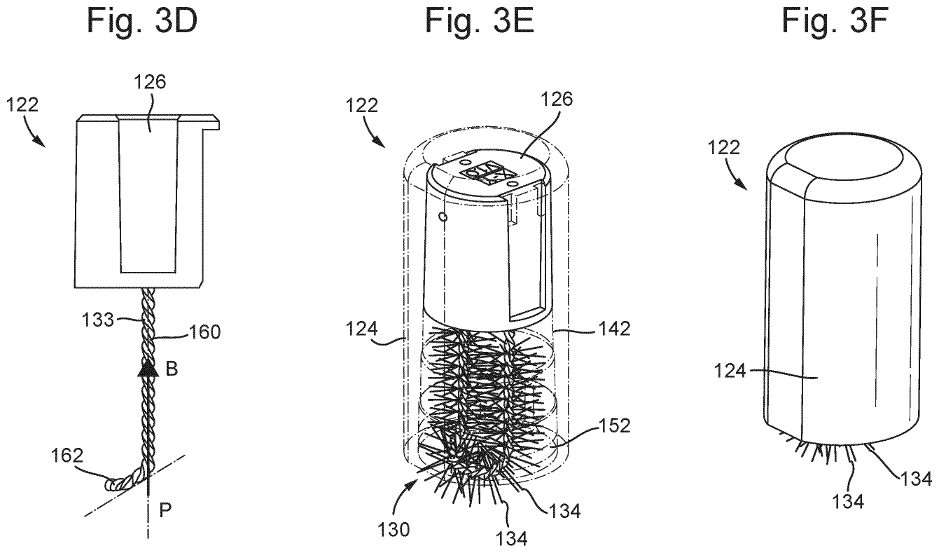

FIGS. 3A-3F show perspective views of a cleaning tool 122 according to various embodiments. The cleaning tool 122 may be used to clean a heating element 104 and/or main housing 105 and/or heating chamber of an aerosol provision device 100 such as an aerosol provision device 100 as described above with reference to FIGS. 1A-1C and 2A-2D. The cleaning tool 122 may also be used to clean other aerosol provision devices.

The cleaning tool 122 comprises a cleaning head 130 having a loop support 133 and a plurality of bristles 134 extending from the loop support 133. The loop support 133 may be formed from at least two strands of wire which are twisted together so as to secure the bristles 134 in positioned therebetween. As shown in FIGS. 3A and 3E, the bristles 134 may extend radially from the loop support 133.

The cleaning tool 122 may be used with an aerosol provision device 100 via engaging with, or partially inserting into, the end of the aerosol provision device 100 with removable cap 106 removed, so as to clean a part of aerosol provision device 100.

The cleaning tool 122 may comprise a loop housing 126. The loop housing 126 may be arranged and adapted to engage with or contact a proximal surface of an aerosol provision device 100. For example, the proximal surface may comprise the inner surface of a main housing 105 as shown, for example, in FIG. 2D.

At least one end of the loop support 133 may be embedded or otherwise secured to the loop housing 126 such that the loop support 133 extends away from the loop housing 126, and, in use (that is, when engaged with an end of aerosol provision device 100), the loop housing 126 may prevent the cleaning tool 122 from being positioned or inserted into the aerosol provision device 100 beyond a desired distance. For example, the loop housing 126 may prevent the cleaning tool 122 from contacting a surface of the aerosol provision device 100 beyond the proximal surface 112 of the aerosol provision device 100 which is desired to be cleaned. As shown in FIGS. 3A-3F, two ends of the loop support 133 are embedded or otherwise secured to the loop housing 126.

As shown in FIG. 3B, the loop support 133 may comprise a first portion 160 provided in a first plane P. In some embodiments wherein the heating element 104 is a blade or pin which pierces or which otherwise is inserted into an aerosol generating article 200 along the blade direction B (as shown in FIG. 2D), the first portion 160 of the loop support 133 of the cleaning tool 122 may be provided in the first plane P such that the blade direction B of the blade heating element 104 (or pin) is in co-planar with the first plane P. In other words, in use, the first portion 160 may be aligned with the blade direction B of the heating element 104. In this way, a larger portion of the plurality of bristles 134 extending from the first portion 160 may be brought into contact with the heating element 104 than otherwise if the heating element 104 were directed in a direction out of plane from the first plane P. This may result in a better quality of cleaning.

The loop support 133 may comprise a second portion 162 which may be angled away from the first plane P (e.g. as shown in FIG. 3D). The second portion 162 may substantially lie in a second plane, or may alternatively be substantially curvilinear such that the second portion is increasingly angled from the first plane P with distance from the first portion 160. The angle of the second plane (or the angle of a tangent taken at a point along the second portion, the tangent lying within the plane perpendicular to the first plane P but parallel with the blade direction B) with respect to the first plane (when measured clockwise in FIG. 3D from the portion of the first plane P below the intersection of the first plane and the second plane or tangent) may be selected from the ranges: 0-30 degrees; 30-60 degrees; or 60-90. As will be understood, if the second portion is substantially curvilinear, the angle of the tangent may increase continuously from approximately zero (at the transition point between the second and first portions) to at most 90 degrees (at the point of the second portion furthest away from the first plane P).

The second portion 162 may be sufficiently angled or bent such that at least a section of the second portion 162 is substantially perpendicular to the first plane P. As will be appreciated, after use, deposits of spent aerosol generating material or un-used aerosol generating material may remain within the main housing 105 and/or heating chamber of the aerosol provision device 100. In particular, deposits left in corners of the main housing 105 and/or the heating chamber may be difficult to reach and clean. Accordingly, the second portion 162 of the loop support 133 of the cleaning tool 122 may therefore be angled such that the second portion 162 of the loop support 133 and/or a portion of the plurality of bristles 134 is arranged to contact at least a portion of a corner of the main housing 105 and/or the heating chamber of the aerosol provision device 100 when the cleaning tool 122 is engaged with the housing 108 of the aerosol generating device 100.

The heating element 104 may have an outer width W1 as shown in FIG. 2D. The loop support 133 may have an inner width W2 as shown in FIG. 3C, wherein the inner width W2 may be greater than the outer width W1 of the heating element 104 such that, in use or engagement of the cleaning tool 122 with the aerosol provision device 100, the loop support 133 may be arranged to surround but not contact the heating element 104 of the aerosol provision device 100.

As will be understood, the heating element 104 of the aerosol provision device 100 may be susceptible to mechanical damage under relatively low physical contact. That is, the heating element 104 may be easily damaged under the actions of a contact force exerted by a user when typically cleaning a surface (e.g. when using cleaning tool 122 to contact and clean the heating element 104). Therefore, the loop support 133 (e.g. both the first portion 160 and second portion 162 of the loop support 133) of the cleaning tool 122 may be configured so as to surround but not contact the heating element 104, such that a user cannot exert a high contact force through the loop support 133 of the cleaning tool 122 onto the heating element 104 whilst engaging and using the cleaning tool 122 on the aerosol provision device 100. Moreover, as will be explained in more detail below, the loop support 133 may be configured such that a user can rotate the cleaning tool 122 relative to the heating element (e.g., as a cleaning action) without the loop support 133 contacting the heating element.

For instance, the cleaning tool 122 may comprise a longitudinal axis which, in use, aligns with a longitudinal axis of the aerosol provision device 100 e.g. of the main housing 105 and/or heating chamber of the aerosol provision device 100. That is, the heating blade direction B may be coaxial with the longitudinal axis of the aerosol provision device 100, such that the cleaning tool 122 in use shares the same longitudinal axis B (as indicated in FIGS. 3B, 3C and 3D).

The first portion 160 of the loop support 133 may comprise two parallel portions of the loop support which are spaced from each other in a direction perpendicular to the longitudinal axis B by a distance greater than a maximum width of the heating element 104 in the direction perpendicular to the longitudinal axis B. The second portion 162 may connect the two parallel portions and be angled or otherwise bent such that the second portion 162 also does not contact the heating element 104.

The cleaning tool 122 may comprise an outer housing 124 which houses the loop housing 126 and the cleaning head 130 as shown in FIGS. 3E and 3F. As shown in FIG. 3E, the outer housing 124 may define a cavity 142 defined between the loop housing 126 and an inner surface of the outer housing 124, which substantially houses the cleaning head 130.

The cavity 142 within the outer housing 124 may be shaped and/or dimensioned to receive a specific part of the aerosol provision device 100, for example the main housing 105 thereof. In some embodiments, the outer housing 124 is substantially cylindrical and the outer housing 124 defines a substantially cylindrical cavity 142 which houses the cleaning head 130.

In some embodiments, the loop support 133 may be removably secured to the loop housing 126 such that the loop support 133 may be replaced.

In some embodiments, the outer housing 124 comprises a cleaning mode engagement mechanism for engaging with the aerosol provision device 100. The cleaning mode engagement mechanism enables the cleaning tool 122 to be rotated relative to the aerosol provision device 100.

For instance, as shown in FIG. 3E the outer housing 124 may comprise a plurality of radially extending lugs 152 which extend around an inner circumference of the outer housing 124. Any number of radially extending lugs 152 may be provided e.g. one or more lugs 152. The radially extending lugs 152 may engage with a corresponding lug and/or recess provided on a portion of the aerosol provision device 100 and hence the lugs 152 may act to secure the cleaning tool 122 to the aerosol provision device 100 with respect to the longitudinal axis of the aerosol provision device 100, but still permit at least partial rotation of the cleaning tool 122 about the longitudinal axis with respect to the aerosol provision device 100. This may improve operation of the cleaning tool 122 as the housing 124 may remain in a fixed position with respect to the longitudinal axis of the aerosol provision device 100 whilst enabling rotation during a cleaning operation.

The one or lugs 152 of the cleaning device 122 may comprise compliant ribs which are configured to snap hook into a corresponding lug and/or recess provided on the aerosol provision device 100 thereby giving tactile feedback to a user when the cleaning tool 122 is attached to an aerosol provision device 100.

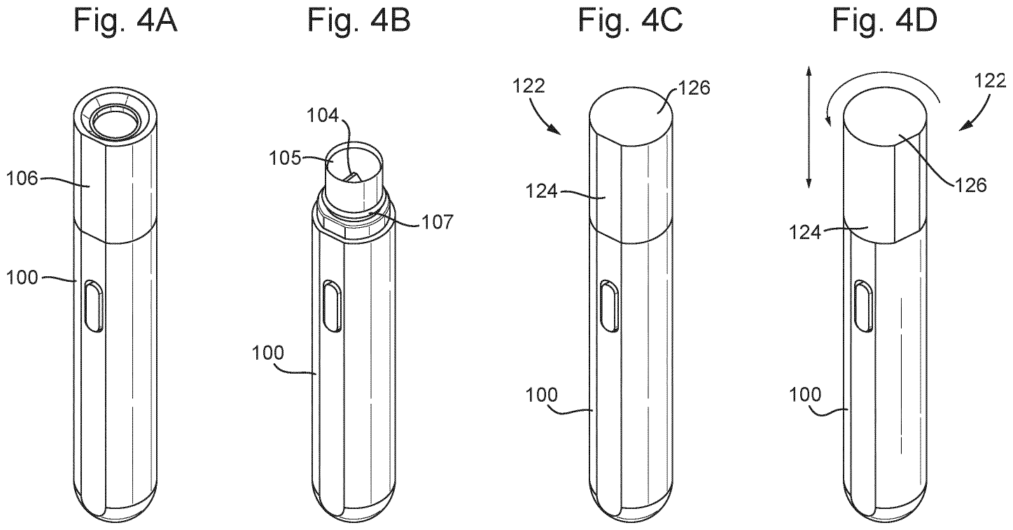

FIGS. 4A-4D depict an exemplary method of use of the cleaning tool 122. As depicted in FIG. 4A, a user may initially seek to clean an aerosol provision device 100 having a removable cap 106 wherein the removable cap 106 is attached to the aerosol provision device 100. In order to commence the cleaning process, the user may first remove the removable cap 106 from the aerosol provision device 100.

An aerosol provision device 100 with the removable cap 106 removed is depicted in FIG. 4B and shows the main housing 105 of the aerosol provision device 100 with a heating element 104 arranged therein. The main housing 105 may comprise one or more circumferential lugs 107 which may extend around the circumference of the main housing 105.

Once the removable cap 106 has been removed, and any aerosol generating article contained within the main housing 105 has been removed, a user may then apply or attach the cleaning tool 122 on to the aerosol provision device 100.

FIG. 4C shows a cleaning tool 122 according to an embodiment attached to the aerosol provision device 100. A user may attach the cleaning tool 122 by inserting the main housing 105 of the aerosol provision device 100 into the cavity 142 which is formed within the housing 124 of the cleaning tool 122.

As the cleaning tool 122 is advanced onto the main housing 105 of the aerosol provision device 100, one or more lugs 152 (see FIG. 3E) provided on the cleaning tool 122 may be caused to engage with the circumferential lug 107 provided on the main housing 105 of the aerosol provision device 100. As a result, the cleaning tool 122 may become secured to the aerosol provision device 100. The cleaning tool 122 is thus attached to the aerosol provision device 100 in use.

With reference to FIGS. 4C and 4D, a user may then repeatedly rotate the cleaning tool 122 so as to cause the cleaning head 130 housed within the outer housing 124 of the cleaning tool to repeatedly rotate in either direction within the outer housing 124. For instance, the rotating may be whilst the cleaning tool 122 remains engaged with the aerosol provision device 100, that is, whilst remaining in the same longitudinal position relative to the aerosol provision device 100.

The cleaning tool 122 is shown in a first position in FIG. 4C and in a second position in FIG. 4D. The described arrangement beneficially provides a quick and convenient means for rotating and thereby cleaning the aerosol provision device 100. As will be appreciated, the shape of the first portion 160 of the loop support 133 may prevent touching and potentially damaging the heating element 104, whilst the angled second portion 162 may enable the bristles 134 to reach the corners of the main housing 105 or the heating chamber to thereby effectively clean those corners. The second portion 162 is also prevented from touching the heating element 104, for instance by requiring that at every point along the second portion 162 the distance of the second portion 162 perpendicular from the longitudinal axis B is at least half the width of the heating element (i.e. [W1]/2). In some embodiments, the second portion 162 may have a constant curvature with respect to the perpendicular distance from the longitudinal axis B, wherein the radius of curvature of the second portion 162 may be the same as half the width W2 of the first portion 160 (i.e. [W2]/2).

As indicated by the longitudinal arrow in FIG. 4D, the above described cleaning mode engagement mechanism for engaging with the aerosol provision device 100 may also be configured for longitudinal motion of the cleaning tool 122 with respect to the aerosol provision device 100 to provide a further degree of motion, enabling additional cleaning of the heating element 104 and/or main housing 105 and/or heating chamber of the aerosol provision device 100.

With reference back to FIGS. 3B-3D, the first portion 160 of loop support 133 may be substantially planar and straight. However, it will be appreciated that the loop support 133 may have any other suitable profile that facilitates cleaning of the heating element 104 within the aerosol provision device 100. The loop support 133 may have different profiles such that it is suitable for cleaning different areas within the aerosol provision device 100.

Similarly, whilst a specific form of bristles 134 have been shown i.e. one which comprises a plurality of uniform bristles, it will be appreciated that the bristles may instead be replaced by any suitable element which will contact a part of the aerosol provision device 100 during use of the cleaning tool 122. For example, the bristles may instead be replaced by a series of blades which perform a cleaning action.

In some embodiments, the outer housing 124 of the cleaning tool 122 may comprise an attachment mechanism for securing the cleaning tool to one or more slots or cut-outs provided in the aerosol provision device 100. For example, the attachment mechanism may comprise a first protrusion for engaging with a first slot or cut-out provided in the aerosol provision device 100. Moreover, the attachment mechanism may comprise a second protrusion having a different shape and/or dimension to the first protrusion, wherein the second protrusion is arranged to engage with a second slot or cut-out provided in the aerosol provision device, wherein the second slot or cut-out has a different shape and/or dimension to the first slot or cut-out. It will be understood that this attachment mechanism may still permit rotational and axial movement (along the longitudinal axis of the cleaning tool and aerosol provision device), however the extent of permitted movement may be restricted.

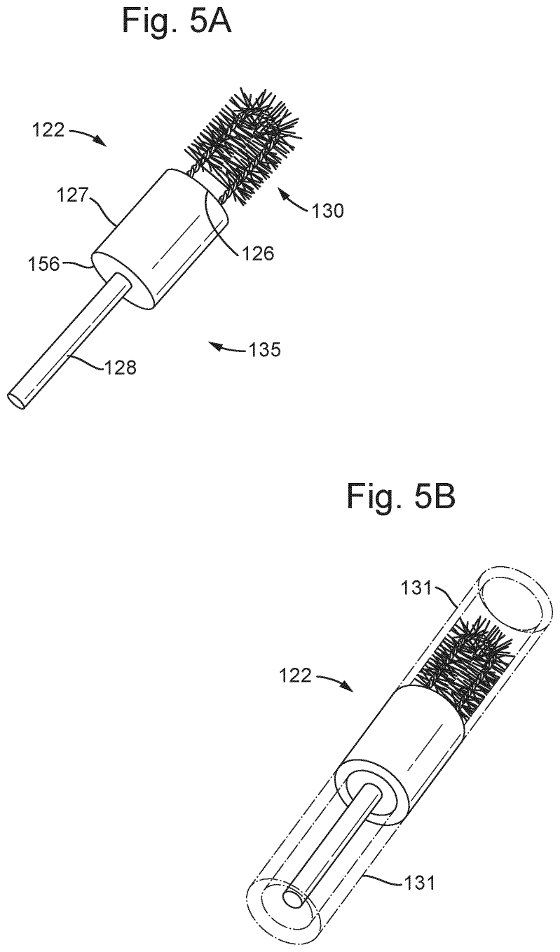

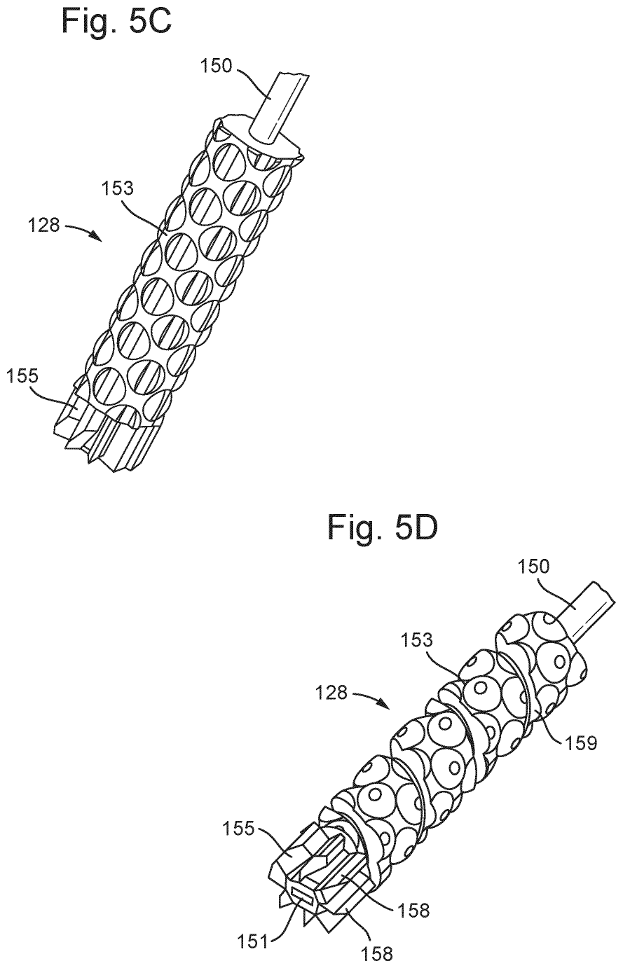

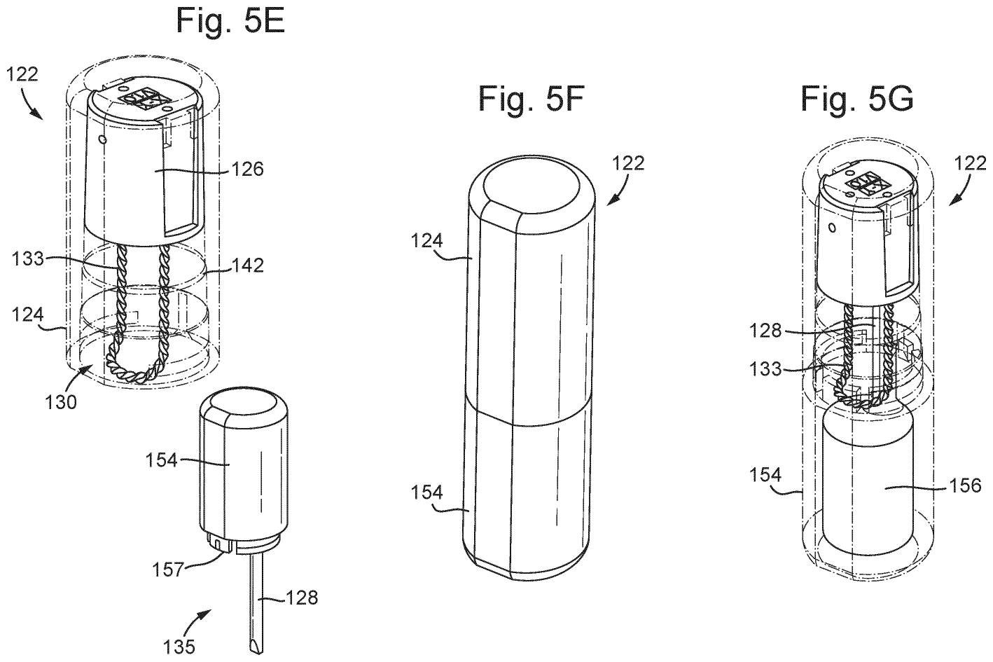

FIGS. 5A and 5B show perspective views of a cleaning tool 122 according to an embodiment. As shown the cleaning tool 122 comprises a handle portion 127. The cleaning head 130 is provided at one end of the handle portion 127 and a scraper tool 135 comprising a scraper 128 is provided at another end of the handle portion 127. As will be understood, the end of the handle portion 127 which provides the scraper tool 135 may comprise a scraper housing 156, wherein an end of the scraper 128 is embedded within the scraper housing 156 or the scraper 128 is otherwise secured to the scraper housing 156.

The scraper 128 may be detachable from the scraper housing 156, for instance to replace the scraper 128. Similar to the loop housing 126 discussed above, the scraper housing 156 may also be arranged and adapted to engage with or contact a proximal surface 112 of the aerosol provision device 100. In embodiments, in use, the scraper housing 156 prevents the cleaning tool 122 from being positioned or inserted beyond the proximal surface 112 of the aerosol provision device 100 such that the scrapper 128 does not extend too far into the aerosol provision device 100 and damage other components.

The scraper 128 can be used to scrape at deposits of spent aerosol generating material and/or aerosol generating material which has not been completely used up which are particularly stuck and are not able to be cleaned via the cleaning head 130.

The scraper 128 and cleaning head 130 may be protected from damage when not in use via cleaning tool caps 131 as shown in FIG. 5B.

In some embodiments, the handle portion 127 comprises a loop housing 126 which is integral with the scraper housing 156.

The scraper 128 may be formed from PEEK. The scraper 128 may be smaller in diameter than the smallest gap between the heating element 104 and the inner wall of the main housing 105 or heater chamber. For instance, in embodiments wherein this gap is 2 mm, then the scraper 128 may be 1.8 mm in diameter so as to be able to fit longitudinally between the heating element 104 and the inner wall of the main housing 105 or heater chamber. Moreover, in embodiments, the scraper 128 may be flexible and/or mechanically weak thereby preventing the user from applying a damaging force through the scraper 128 on to the heating element 104 or another potentially vulnerable component of the aerosol provision device 100.

FIGS. 5C and 5D show perspective views of a scraper 128 according to various embodiments. As shown, the scraper 128 may comprise a straight shaft 150 having an end 151 distal from the scraper housing 156 (not shown in FIG. 5C or 5D) and a flexible layer 153 surrounding a portion of the straight shaft 150.

The scraper 128 may further comprise a scraper tip portion 155 positioned at the distal end 151 of the straight shaft 150.

The scraper tip portion 155 may be formed from PEEK. The scraper tip portion 155 may be configured so as to loosen tobacco deposits that may have built up at the base of the heating element 104, or within main housing 105 or heating chamber of the aerosol provision device 100. For instance, the scraper tip portion 155 may comprise a plurality of protrusions 158 which extend substantially radially outward and optionally each having a sharpened tip converging towards the distal end 151 such that the scraper tip portion 155 can efficiently loosen tobacco deposits e.g. via rotation of the straight shaft 150 by a user. The scraper tip portion 155 may further comprise an additional sharpened tip at the distal end 151 and converging beyond the straight shaft 150. This may be beneficial in embodiments wherein the main housing 105 has a closed end 175 (as shown in FIG. 1C).

The sharpened tip at the distal end 151 may be configured to contact and therefore clean the bottom corners and edges of the main housing 105 or heating chamber of aerosol provision device 100, where material is likely to build up.

The flexible layer 153 may be configured so as to prevent damage when in contact with the heating element 104. The flexible layer 153 may comprise silicone or other suitable flexible molded material.

The flexible layer 153 may comprise bump features 153, which may be configured so as to pick up detritus of aerosol generating material from the surface of the heating element 104 and/or the inner walls of the main housing 105 or heating chamber of aerosol provision device 100. For instance, the bump features may comprise domes each having a slot-like recess (as shown in FIG. 5C) and/or a circular concave recess (as shown in FIG. 5D).

The flexible layer 153 may comprise a spiral channel 159, which may help to lift dirt out of the aerosol provision device 100.

In some embodiments, the cleaning tool 122 may comprise only the scraper tool 135 e.g. comprising only the scraper 128 as shown in FIGS. 5C and 5D in order to clean the aerosol provision device 100 i.e. the cleaning head 130 may be omitted.

FIGS. 5E-5G show perspective views of a cleaning tool 122 according to an alternative embodiment, wherein cleaning tool 122 comprises a scraper tool 135 which is detachable from the cleaning head 130. The scraper tool 135 comprises a scraper 128. As shown, when not in use or engagement with an aerosol provision device 100, the scraper tool 135 may be arranged and adapted to engage with the cleaning head 130 so as to secure the scraper tool 135 to the cleaning head 130. For instance, the scraper tool 135 may comprise a scraper outer housing 154 which is configured to be partially inserted within the cavity 142 of the outer housing 124 in which cleaning head 130 is housed as shown in FIGS. 5F and 5G.

For example, in embodiments wherein the cleaning tool 122 comprises an outer housing 124 having a cleaning mode engagement mechanism for engaging with an aerosol provision device 100 which enables the cleaning tool 122 to be rotated relative to the aerosol provision device 100, the scraper tool 135 may comprise scraper outer housing 154 having an attachment mechanism 157 configured to engage with the cleaning mode engagement mechanism of the outer housing 126 of the cleaning head 130 so as to secure the scraper tool 135 to the cleaning head 130 without relative rotation of the scraping head 133 with respect to the cleaning head 130.

In embodiments, the scraper tool 135 may be configured such that, when the scraper tool 135 is secured to the cleaning head 130, the scraper 128 may be positioned within the loop support 133.

As will be understood, the scraper 128 may be configured to be used by a user to scrape and remove deposits of spent aerosol generating material or un-used aerosol generating material remaining within the main housing 105 or heating chamber of the aerosol provision device 100. Accordingly, the handle portion 127 or scraper tool 135 can be freely manoeuvred by a user so as to reach, with the scraper 128, deposits of spent aerosol generating material or un-used aerosol generating material which are inconveniently positioned and hard to reach.

The scraper 128 may comprise a thin stick. For instance, the scraper may comprise a thin cylinder or may comprise a thin strip. The end of the scraper 128 may comprise a sharpened point, such that at least one angled surface tapers or converges to an edge at the end of the scraper 128.

The length of the scraper 128 may be: (i) at least the length of a heating chamber of an aerosol provision device; (ii) at least 1.2 times the length of a heating chamber of an aerosol provision device; or (iii) at least 1.4 times the length of a heating chamber of an aerosol provision device.

The length of the loop support 133 (as measured from loop housing 126 to the portion of the loop support 133 distal furthest from the loop housing 126) may be: (i) at least the length of the main housing 105 or a heating chamber of an aerosol provision device 100; (ii) at least 1.2 times the length of the main housing 105 or a heating chamber of an aerosol provision device 100; or (iii) at least 1.4 times the length of the main housing 105 or a heating chamber of an aerosol provision device 100.

In embodiments, the cleaning tool 122 may further comprise a silicone support plug (not shown), wherein, in use or engagement with an aerosol provision device 100, the silicone support plug is configured so as to support the heating element 104 of the aerosol provision device 100, such that the heating element 104 is protected from snapping or otherwise breaking under the action of a contact force exerted by a user through the loop structure 130 and/or scraper 128 of the cleaning tool onto the heating element 104 whilst engaging or using the cleaning tool 122 on the aerosol provision device 100.

In some embodiments, the cleaning head 130 may comprise a silicone plug, the silicone plug being positioned adjacent to the loop support 133.

In embodiments, the cleaning tool 122 may comprise two or more loop supports 133.

The plurality of bristles 134 may be formed from PEEK material.

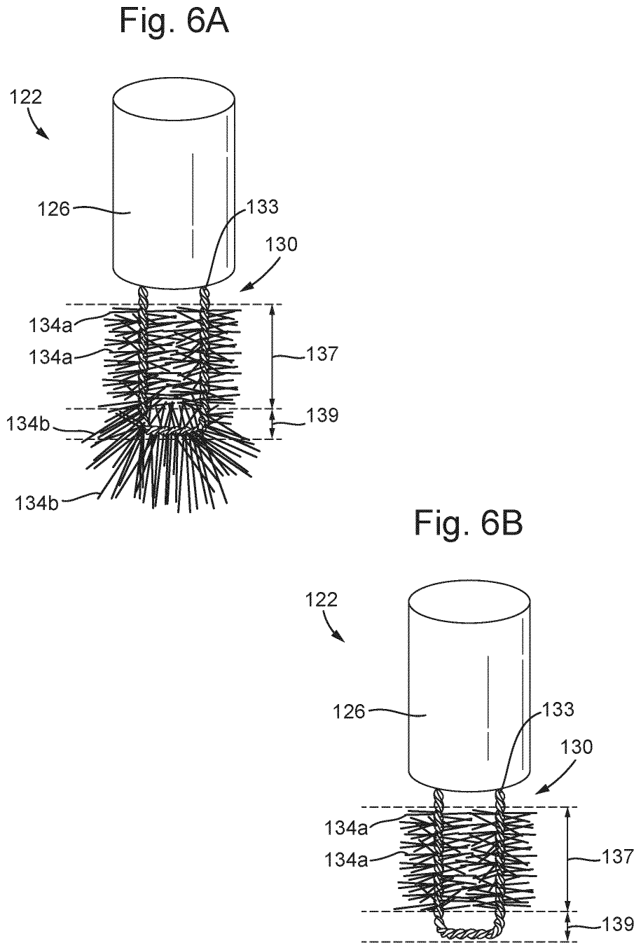

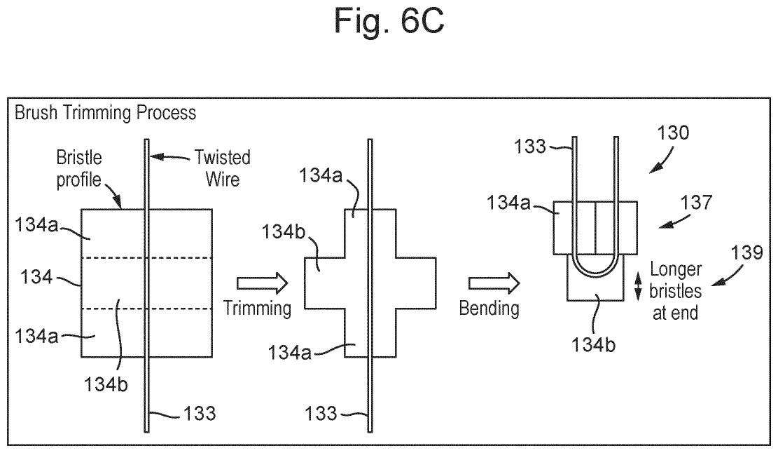

FIG. 6A shows a cleaning tool 122 for cleaning an aerosol provision device 100 according to an embodiment. The loop support 133 can be defined by a first section 137 that is proximal to the loop housing 126 and second section 139 distal from the loop housing 126. The loop support 133 may be a metal wire (or formed from a plurality of strands of metal wire) so that it can be readily deformed into the desired shape, with the plurality of bristles 134 extending from the metal wire.

The bristles may comprise PEEK and may have a thickness of 0.1-0.3 mm. According to an embodiment the bristles have a thickness of 0.1-0.2 mm or 0.2-0.3 mm.

FIG. 6B shows a perspective view of a cleaning tool 122 according to another embodiment and will be described in more detail below.

FIG. 6C illustrates the process of fabricating a cleaning tool 122 according to various embodiments.

When forming the cleaning tool 122, one end of the loop support 133 prior to bending (i.e. when the loop support 133 is straight, as shown in the left hand panel of FIG. 6C) may be inserted into the loop housing 126.

The bristles 134 may be inserted into the loop support 133 and then trimmed to a desired length (e.g. middle panel of FIG. 6C). The loop support 133 may then be bent so that the free end is inserted into the loop housing 126.

Alternatively, the bristles 134 maybe provided on the loop support 133 whereupon the bristles 134 may then be trimmed to length, the loop support 133 may then be bent and ends of the loop support 133 may then be attached or inserted into a loop housing 126.

According to an embodiment, the loop support 133 may be divided into two sections. A first section 137 of the loop support 133 may be proximal to the loop housing 126 and the second section 139 of the loop support 133 may be distal from the housing 126.

The bristles 134a in the first section 137 may extend from the loop support 133 a first distance and the bristles 134b in the second section 139 may extend from the loop support 133 a second distance, wherein the second distance is greater than the first distance. In other words, the bristles 134a in the first section 137 may be trimmed so that they are shorter than the bristles 134b in the second section 139. Having the bristles 134b of the second section 139 longer than the bristles 134a of the first section 137 is particularly useful when cleaning an aerosol provision device 100 that has heating chamber in a borehole configuration i.e. there is only once entrance hole in which the cleaning tool 122 can enter (for instance, as described above with reference to FIGS. 1A-1C, 2A-2D, and 4A-4D, wherein the main housing 105 has a closed end 175 as shown in FIG. 1C). In this scenario, the longer bristles 134b of the second section 139 are able to contact and therefore clean the bottom corners and edges of the main housing 105 or heating chamber of aerosol provision device 100, where material is likely to build up.

It will be understood that the fabrication method shown in FIG. 6C may enable the provision of bristles 134b in the second section 139 which are longer than which could otherwise be provided in alternative fabrication methods.

In embodiments wherein the loop support 133 comprises a first portion 160 and a second portion 162, the first portion 160 and the second portion 162 may comprise the first section 137 and the second section 139 respectively, the two sections 137,139 having different bristle lengths.

According to various embodiments, the second section 139 of the loop support 133 may have no bristles (as shown in FIG. 6B). This may be particularly advantageous in cleaning an aerosol provision device having a through-bore heating chamber (e.g. a cylindrical heating chamber which is open at both ends), such that, in use, the cleaning tool 122 is pushed all the way through the through-bore so as to clean it. In fabricating such a cleaning tool 122, a single bristle profile may be provided, wherein the bristles extending from the section of the loop support 133 which will form the second section 139 (e.g. labelled 134b in FIG. 6C) are fully trimmed such that the second section 139 of the loop support 133 may have no bristles. Alternatively, two separate bristle profiles may be provided, such that no further trimming is required.

In embodiments, the bristles 134 may be trimmed to form the bristles 134a in the first section 137 and the bristles 134b (or lack thereof) in the second section 139 after the loop support 133 has been bent into shape or after the bent loop support 133 has been secured to the loop housing 126.

In embodiments wherein the bristles 134 and/or at least a part of the scraper 128 are formed from PEEK, it will be appreciated that the bristles 134 and/or at least a part of the scraper 128 will have a substantial temperature resistance so as to not be damaged or softened (e.g. via at least partial melting) when used to clean a portion of an aerosol provision device 100 which may be at a relatively high temperature (e.g. just after use of the aerosol provision device 100 by a user). Moreover, the aerosol provision device 100 may be activated to at least partially heat the main housing 105 or heating chamber during a clean, so as to at least partially soften or melt or detach left-over deposits of aerosol generating material, which facilitates removal thereof via the heat-resistant bristles 134 and/or at least a part of the scraper 128 without damaging the bristles 134 and/or at least a part of the scraper 128.

The loop housing 126 and/or the scraper housing 156 according to some embodiments may also be formed of PEEK, however the material of the housings 126,156 may be any suitable material. In embodiments wherein at least the scraper housing 156 is formed from PEEK, the corresponding scraper 128 may be overmolded with the scraper housing 156 during fabrication so as to be provided as an integral piece. In embodiments wherein at least the loop housing 126 is formed from PEEK, the loop support 133 (or one or more wires which form the loop support 133) may be heat staked into the loop housing 126 during fabrication.

In embodiments, the bristles 134 of the loop support 133 may be long enough so as to touch the inner wall of main housing 105 or heating chamber of aerosol provision device 100 and at least partially bend when moved relative to the aerosol provision device 100 (be it via rotation with respect to the longitudinal axis or via axial translation with respect to the longitudinal axis).

In embodiments, the wire which forms the loop support 133 or single shaft 173 may be formed from stainless steel.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A cleaning tool for an aerosol provision device, the cleaning tool comprising:
a cleaning head comprising a loop support and a plurality of bristles extending from the loop support.

2. (canceled)

3. (canceled)

4. A cleaning tool as claimed in claim 1, further comprising a loop housing, wherein the loop support extends from the loop housing.

5. A cleaning tool as claimed in claim 4, wherein the loop housing is arranged and adapted to engage with or contact a proximal surface of an aerosol provision device.

6. A cleaning tool as claimed in claim 4, wherein the loop support comprises a first section proximal to the loop housing and a second section distal from the loop housing, wherein the bristles extending from the first section of the plurality of bristles extend from the loop support by a first distance and the bristles extending from the second section of the plurality of bristles extend from the loop support by a second distance, wherein the second distance is greater than the first distance.

7. (canceled)

8. A cleaning tool as claimed in claim 1, wherein the loop support comprises a first portion provided in a first plane.

9. A cleaning tool as claimed in claim 8, wherein the loop support comprises a second portion which is angled away from the first plane.

10. (canceled)

11. A cleaning tool as claimed in claim 8, wherein the first portion comprises two portions which are spaced apart from each other, and the second portion connects the two portions of the first portion.

12. A cleaning tool as claimed in claim 11, wherein the two portions of the first portion are parallel and are spaced apart from each other in a direction perpendicular to a longitudinal axis of a heating element of an aerosol provision device by a distance greater than a maximum width of the heating element in the direction perpendicular to the longitudinal axis, and wherein the second portion connecting the two parallel portions is angled or otherwise bent such that the second portion does not contact the heating element in use or engagement of the cleaning tool with an aerosol provision device.

13. A cleaning tool as claimed in claim 1, wherein, in use or engagement of the cleaning tool with an aerosol provision device, the loop support is arranged to surround but not contact a heating element of the aerosol provision device.

14. A cleaning tool as claimed in claim 1, wherein the cleaning tool comprises an outer housing defining a cavity which houses the loop support and which is dimensioned to receive, in use, an outer wall of a heating chamber or housing of an aerosol provision device.

15. A cleaning tool as claimed in claim 14, wherein the outer housing is substantially cylindrical and wherein the outer housing defines a substantially cylindrical cavity which houses the cleaning head.

16. A cleaning tool as claimed in claim 14, wherein the outer housing comprises a cleaning mode engagement mechanism for engaging with an aerosol provision device, the cleaning mode engagement mechanism enabling the cleaning tool to be rotated relative to the aerosol provision device.

17. A cleaning tool as claimed in claim 14, wherein the outer housing comprises an attachment mechanism for securing the cleaning tool to one or more slots or cut-outs provided in an aerosol provision device.

18. (canceled)

19. A cleaning tool as claimed in claim 1, wherein the cleaning tool comprises a scraper tool which is detachable from the cleaning head, wherein the scraper tool comprises a scraper, and wherein, when not in use or engagement with an aerosol provision device, the scraper tool is arranged and adapted to engage with the cleaning head so as to secure the scraper tool to the cleaning head.

20. A cleaning tool as claimed in claim 19, wherein the scraper tool comprises a scraper housing from which the scraper extends, and wherein the scraper comprises:
a straight shaft having an end distal from the scraper housing;
a flexible layer surrounding a portion of the straight shaft; and
a scraper tip portion positioned at the distal end of the straight shaft.

21. (canceled)

22. A cleaning tool as claimed in claim 20, wherein the flexible layer comprises bump features.

23. A cleaning tool as claimed in claim 20, wherein the flexible layer comprises a spiral channel.

24. A cleaning tool as claimed in claim 1, wherein the cleaning tool further comprises a silicone support plug, wherein, in use or engagement with an aerosol provision device, the silicone support plug is configured so as to support a heating element of the aerosol provision device, such the heating element is protected from snapping or otherwise breaking under the action of a contact force exerted by a user through the loop structure of the cleaning tool onto the heating element whilst engaging the cleaning tool with the aerosol provision device and/or when using the cleaning tool on the aerosol provision device.

25. (canceled)

26. (canceled)

27. (canceled)

28. A method of cleaning an aerosol provision device comprising:
attaching a cleaning tool as claimed in claim 1 to an aerosol provision device such that the cleaning tool and the aerosol provision device share a longitudinal axis; and:
(i) rotating the cleaning tool relative to the aerosol provision device about the longitudinal axis by at least a partial rotation; and/or
(ii) translating the cleaning tool relative to the aerosol provision device axially along the longitudinal axis in at least one direction.

29. (canceled)

30. An aerosol provision system comprising:
an aerosol provision device configured to produce aerosol from an aerosol generating article; and
a cleaning tool according to claim 1.

31. (canceled)
